(19) United States
(12) Patent Application Publication
(10) Pub. No.: US 2006/0102811 A1
(43) Pub. Date: May 18, 2006

(54) Central distribution pole, and a support and a manufacturing method corresponding thereto

(75) Inventors: Herve Musset, Pierrefitte Sur Sauldre (FR); Nicolas Sevestre, Orleans (FR)

Correspondence Address: YOUNG & THOMPSON, 745 SOUTH 23RD STREET, 2ND FLOOR, ARLINGTON, VA, 22202, US

(73) Assignee: MAQUET S.A., ARDON (FR)

(21) Appl. No.: 11/262,798

(22) Filed: Nov. 1, 2005

(30) Foreign Application Priority Data
Nov. 17, 2004 (FR) 04 12204

(51) Int. Cl. F16L 3/00

(52) U.S. Cl. 248/121

(57) ABSTRACT

This central pole (6) for supporting a main arm, in particular for lighting, extends along a central axis (X-X), has a fastening end (20) and a free end (22), and is provided with main and secondary tubular elements (24A, 24B) forming main and secondary housings for holding main and secondary fastening elements (44, 46). Each of these tubular elements (24A, 24B) defines a proximal end (26A, 26B) facing towards the fastening end (20) of the pole (6) and a distal end (28A, 28B). The pole is applicable to lighting distribution supports in operating theaters.

The present invention relates to a central support pole for supporting a main arm, in particular for lighting, the pole being of the type:

extending along a central axis;

presenting a fastening end and a free end situated remote from the fastening end; and

being provided with a main tubular element forming a main housing adapted to hold a main fastening element for a main arm.

The invention relates in particular to distribution supports for lighting in operating theaters.

### BACKGROUND OF THE INVENTION

Distribution supports are known for fastening to the ceiling of an operating theater, and they comprise a central pole from which a plurality of distribution arms are suspended.

Each distribution arm is provided with a free end having fastened thereto either a light fitting, or else some other device that is useful for surgical operations, such as a monitor screen or a module for distributing fluids and electricity.

Prior art poles and installations are made up of a large number of parts and present manufacturing and assembly costs that are large.

### OBJECTS AND SUMMARY OF THE INVENTION

An object of the present invention is to mitigate those drawbacks and to propose a distribution support pole that is easy and inexpensive to manufacture.

To this end, the invention provides a distribution support pole as specified above, the pole being provided with a secondary tubular element forming a secondary housing adapted to hold a secondary fastening element for a secondary arm, and each of the tubular elements defining a proximal end facing towards the fastening end of the pole and a distal end facing away from the fastening end.

In particular embodiments, the pole of the invention further comprises one or more of the following characteristics:

the main and secondary tubular elements are of different axial lengths;

the axial length of the main tubular element is longer than the axial length of the secondary tubular element;

the proximal ends of the tubular elements are axially at the same level, and the fastening end of the central pole is formed by the main and secondary tubular elements;

the distal ends of the main tubular element and of the secondary tubular element are axially at the same level;

the distal ends of the main tubular element and of the secondary tubular element are axially offset;

the tubular elements are connected together by material bonding, in particular by welding;

the tubular elements are formed by an extrusion extending along an extrusion direction;

the fastening end presents a cross-section of outline that is defined, preferably exclusively, by generator lines of the extrusion;

the free end of the central pole presents a cross-section of outline that is defined exclusively by generator lines of the extrusion;

the extrusion has an end portion adjacent to the free end, and presenting a cross-section of outline that is situated exclusively inside the generator lines of the outline of the extrusion; and

the extrusion is an extrusion of an aluminum-based alloy.

The invention also provides a distribution support, in particular for lighting, of the type comprising a central pole and at least one main support arm, wherein the central pole is a central pole as defined above.

In particular embodiments, the support further comprises the following characteristics:

a fastening sleeve, constituted by a part that is distinct from the tubular elements is inserted in the main housing; and

the central pole includes a central channel for fastening a main arm, and at least one side channel for fastening a secondary arm, and in each of said channels, there is inserted a support bushing adapted to support an arm.

The invention also provides a method of manufacturing a pole as defined above, the method comprising the following successive steps:

providing an extruded blank; and

cutting the extruded blank to a length corresponding to the length of the extrusion.

### BRIEF DESCRIPTION OF THE DRAWINGS

The invention can be better understood on reading the following description, given purely by way of example and made with reference to the accompanying drawings, in which:

FIG. 1 is a perspective view of a distribution support of the invention;

FIG. 2 is a side view, partially in section, of the FIG. 1 support;

FIG. 3 is a perspective view of the FIG. 1 distribution support with two light fittings and two monitor screens; and

FIGS. 4 and 5 show variants of the distribution support.

### MORE DETAILED DESCRIPTION

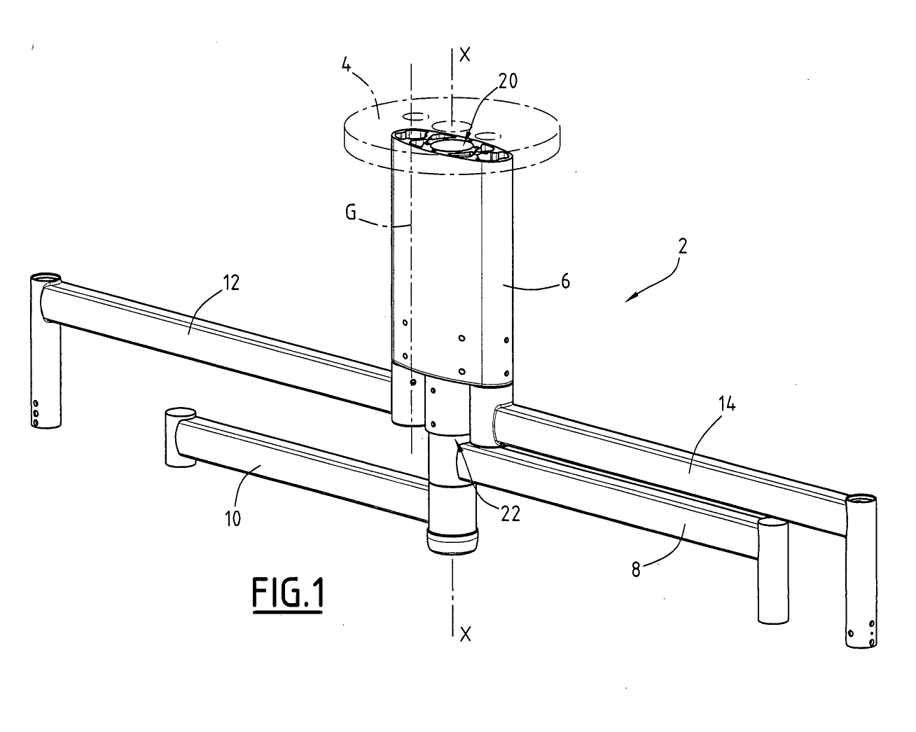

FIG. 1 shows a distribution support of the invention given overall reference 2.

The support 2 has a fastening flange in the form of a disk 4, a central pole 6 with two main arms 8, 10, and two secondary arms 12, 14. The distribution support 2 is for fastening via the fastening flange 4 to the ceiling of a room in a hospital, for example an operating theater.

Each of the main or secondary arms 8 & 10 or 12 & 14 is adapted to carry at a respective end a device such as a light fitting 16, a screen 18, or a fluid and electricity distribution block 17.

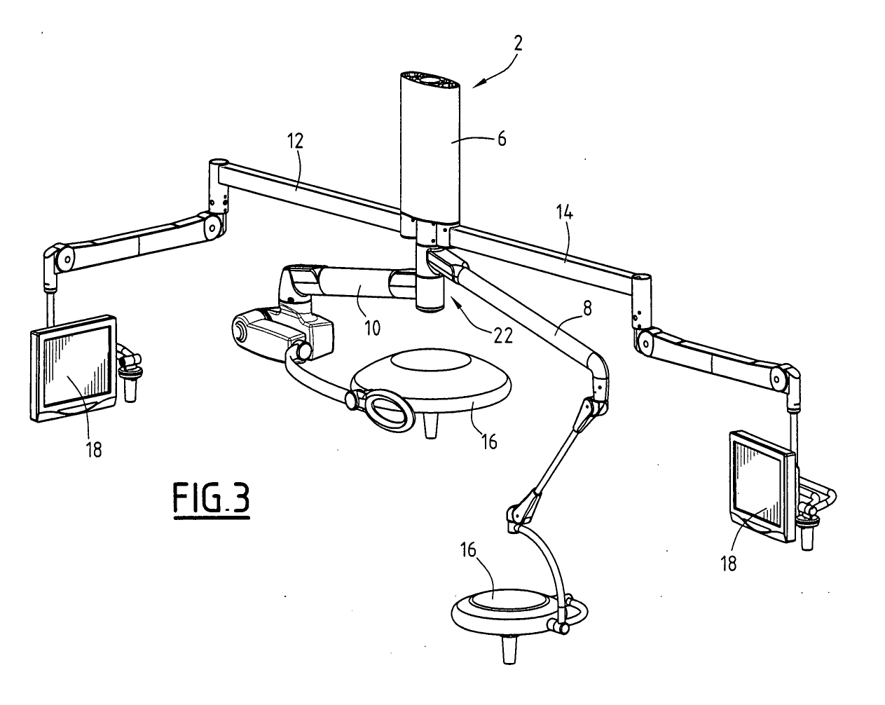

An example of a configuration for the support 2 is shown in FIG. 3. Each of the main arms 8, 10 carries a light fitting 16 and each of the secondary arms 12, 14 carries a monitor screen 18.

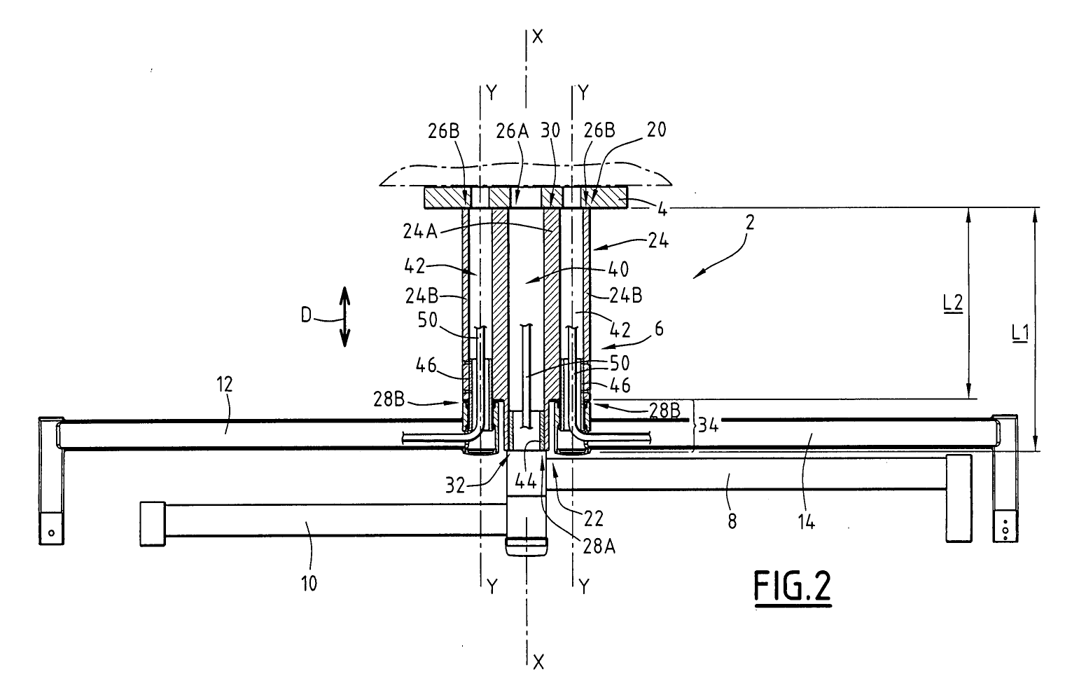

With reference to FIG. 2, the central pole 6 has a fastening end 20 which is fastened to the fastening flange 4 via screws (not shown), and it also has a free end 22 situated remote from its fastening end 20. In the mounted state, the fastening end 20 constitutes the top end of the pole 6 while the free end 22 constitutes the bottom end.

In a variant, the flange 4 is welded to the pole 6.

The pole 6 extends along a central axis X-X that is vertical in the mounted state.

The central pole 6 is constituted by an extruded section member 24 which extends in an extrusion direction D parallel to the axis X-X.

The extrusion 24 is constituted by a main extrusion portion 24A which is a central extrusion portion, and two secondary extrusion portions 24B which are side extrusion portions.

The main extrusion portion 24A is of length L1 measured along the axis X-X, while the secondary extrusion portions 24B are each of axial length L2, measured along the axis X-X.

The main extrusion portion 24A has a proximal end 26A, and each of the secondary extrusion portions 24B has a respective proximal end 26B, these ends 26A and 26B facing towards the fastening end 20. The proximal ends 26A and 26B are level with one another and constitute the fastening end 20.

The main extrusion portion 24A forms a distal end 28A, and each of the extrusion portions 24B forms a respective distal end 28B. These ends 28A and 28B all face towards the free end 22.

The length L1 is longer than the length L2 so the ends 28B are axially offset from the end 28A such that the ends 28A form the free end 22 of the pole 6.

Furthermore, the extrusion 24 has rectilinear generator lines G extending in the direction D and forming the outline of the extrusion 24. One such generator line G is shown in FIG. 1.

With reference again to FIG. 2, the fastening end 20 has a front surface 30 which extends perpendicularly to the extrusion direction D and forms a cross-section for the extrusion having an outline defined exclusively by the generator line G of the extrusion 24. This fastening end 20 is very easy to make, merely by cutting perpendicularly to the axis X-X.

The extrusion 24 has a front surface 32 forming the free end 22, and of a cross-section taken perpendicularly to the axis X-X that presents an outline that lies exclusively inside the generator line G.

More particularly, the extrusion 24 has an end portion 34 adjacent to the free end 22 and of cross-section presenting an outline that is situated entirely inside the outline defined by the generator line G. This end portion 34 has a cylindrical outside surface of circular section and it is made integrally with the remainder of the extrusion 24. Thus, the end portion 34 constitutes a fastening sleeve.

The main extrusion portion 24A forms a single central channel 40 of circular section about the axis X-X, and each of the secondary extrusion portions 24B forms a single side channel 42, each side channel extending along a respective axis Y-Y parallel to the axis X-X. The central channel 40 opens to in the front surface 32.

A main support bushing 44 is inserted in the central channel 40 and is fastened therein. This bushing 44 supports the two main arms 8 and 10.

A secondary support bushing 46 is inserted in each of the side channels 42 and is fastened therein, with each of these bushings 46 supporting a respective one of the secondary arms 12 and 14. Furthermore, each secondary support bushing 46 extends beyond the corresponding side channel 42 in the direction directed towards the face end 22.

More precisely, each of the bushings 44, 46 carries ball bearings whereby the arms 8 to 14 are hinged to the pole 6.

Thus, the central channel 40 forms a main housing for the bushing 44 and each side channel 42 forms a secondary housing for a respective one of the bushings 46.

In each of the channels 40 and 42, there extends a power line 50 comprising either an electric cable, or a fluid feed pipe, or a combined fluid and electricity feed line. Each line 50 extends over the length L1 or L2 along the associated channel 40, 42. Thus, the need for separate parts for hiding the lines 50 is eliminated.

It should be observed that the extrusion 24 is preferably an extrusion of an aluminum-based alloy, thereby leading to a support that is light in weight.

The line 50 extends between the secondary bushing 46 and the secondary arm 12 or 14 around one single 90° bend.

The central pole 6 is manufactured as follows.

Firstly, an extruded blank is provided of length greater than or equal to the length L1 of the extrusion portion 24A, but of cross-section that is identical to the cross-section of the extrusion 24.

Thereafter the extrusion blank is, where appropriate, cut at one end perpendicularly to the extrusion direction D so as to form the fastening end 22 of the extrusion 24, and the extrusion blank is also cut at the other end, likewise perpendicularly to the extrusion direction D, and at a distance from the end 26 that is identical to the length L1 of the extrusion portion 24A.

Thereafter, the end portion 34 is machined to remove swarf, e.g. by turning.

The support is assembled as follows.

Firstly, the fastening flange 4 is screwed to the fastening end 22 of the pole 6.

Thereafter, the support bushings 44 and 46 are fastened by means of screws in the channels 40 and 42.

Finally, the main arms 8 and 10 are fastened by ball bearings to the support bushing 44, and the secondary arms 12 and 14 are fastened to the support bushing 46, likewise via bearings.

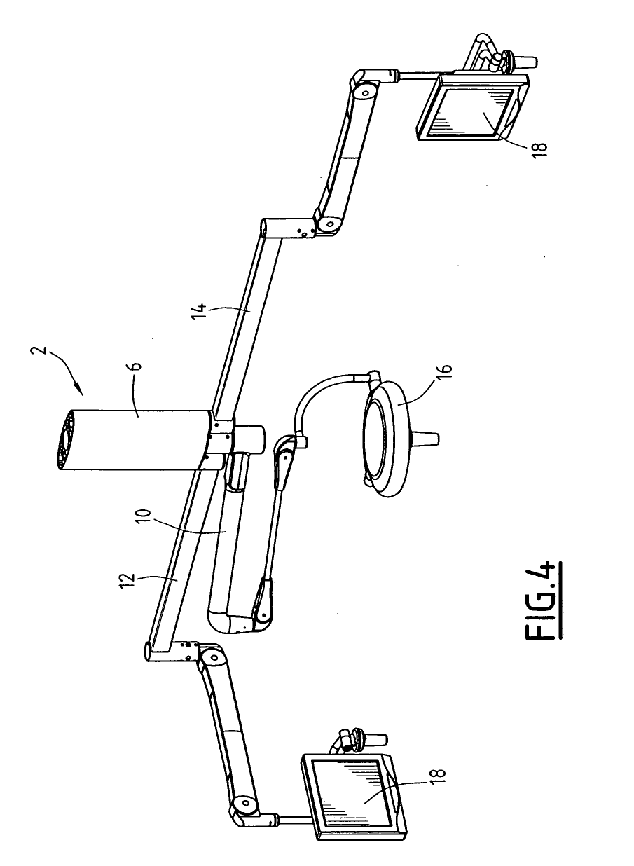

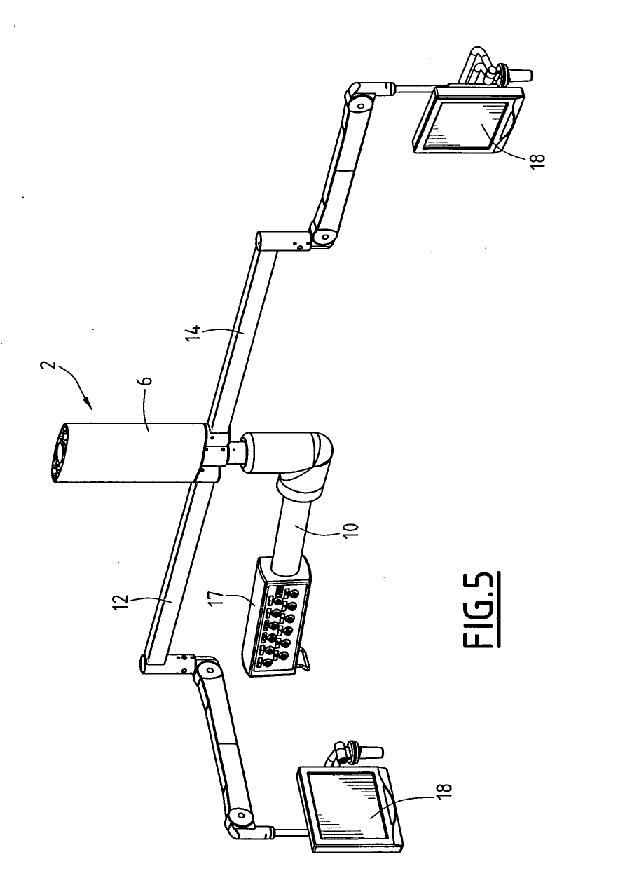

FIGS. 4 and 5 show variants of the support 2.

The description below relates solely to the differences compared with the support 2. Elements that are identical or analogous carry the same references.

The support 2 in FIG. 4 has only one main arm 10, the main arm 8 being omitted. Consequently, the support bushing 44 is axially shorter than the bushing 44 of the support 2 in FIG. 3.

The support 2 in FIG. 5 only has one main arm 10 with a fluid and electricity distribution block 17 secured thereto.

In a variant (not shown), the free end 22 of the extrusion 24 has a cross-section of outline that is defined solely by generator lines G of the extrusion 24. Under such circumstances, the distal ends 26A and 26B are axially at the same level. The end 22 of the extrusion 24 is obtained solely by cutting the extrusion transversely to the extrusion direction D. This variant increases the angular range available to the secondary arms.

Under such circumstances, the pole 6 may have a central fastening sleeve constituted by a part that is separate from the extrusion 24 and that is fastened to the distal end thereof. Thus, the free end of the pole is formed by the central fastening sleeve.

In a variant, the pole is made by welding together three tubular parts, each having a single channel.

The use of an extrusion for forming a portion of the central pole 6 serves to reduce the number of individual parts that need to be assembled together, such that the support 2 is inexpensive to manufacture.

In addition, the extrusion 24 is large in section and therefore presents a high degree of stiffness for given weight.

The pole of the invention enables additional arms to be put into place when it is installed in a hospital.

What is claimed is:

1. A central support pole for supporting a main arm, in particular for lighting, the pole being of the type:
extending along a central axis;
presenting a fastening end and a free end situated remote from the fastening end; and
being provided with a main tubular element forming a main housing adapted to hold a main fastening element for a main arm,
the pole being provided with a secondary tubular element forming a secondary housing adapted to hold a secondary fastening element for a secondary arm, and each of the tubular elements defining a proximal end facing towards the fastening end of the pole and a distal end facing away from the fastening end.

2. A pole according to claim 1, wherein the main and secondary tubular elements are of different axial lengths.

3. A pole according to claim 2, wherein the axial length of the main tubular element is longer than the axial length of the secondary tubular element.

4. A pole according to claim 3, wherein the proximal ends of the tubular elements are axially at the same level, and wherein the fastening end of the central pole is formed by the main and secondary tubular elements.

5. A pole according to claim 1, wherein the distal ends of the main tubular element and of the secondary tubular element are axially at the same level.

6. A pole according to claim 1, wherein the distal ends of the main tubular element and of the secondary tubular element are axially offset.

7. A pole according to claim 1, wherein the tubular elements are connected together by material bonding, in particular by welding.

8. A pole according to claim 1, wherein the tubular elements are formed by an extrusion extending along an extrusion direction.

9. A pole according to claim 4, wherein the tubular elements are formed by an extrusion extending along an extrusion direction, and wherein the fastening end presents a cross-section of outline that is defined, preferably exclusively, by generator lines of the extrusion.

10. A pole according to claim 5, wherein the tubular elements are formed by an extrusion extending along an extrusion direction, and wherein the free end of the central pole presents a cross-section of outline that is defined exclusively by generator lines of the extrusion.

11. A pole according to claim 8, wherein the extrusion comprises a main extrusion portion and a secondary extrusion portion.

12. A pole according to claim 6, wherein the tubular elements are formed by an extrusion extending along an extrusion direction, and wherein the extrusion has an end portion adjacent to the free end, and presenting a cross-section of outline that is situated exclusively inside the generator lines of the outline of the extrusion.

13. A pole according to claim 8, wherein the extrusion is an extrusion of an aluminum-based alloy.

14. A pole according to claim 1, characterized in that the secondary fastening element (46) is a support bushing which extends beyond the secondary housing (24B) in the direction towards the free end (22).

15. A distribution support, in particular for lighting, of the type comprising a central pole and at least one main support arm, wherein the central pole is a central pole according to claim 1.

16. A support according to claim 15, wherein a fastening sleeve, constituted by a part that is distinct from the tubular elements is inserted in the main housing.

17. A support according to claim 16, wherein the central pole includes a central channel for fastening a main arm, and at least one side channel for fastening a secondary arm, and wherein, in each of said channels, there is inserted a support bushing adapted to support an arm.

18. A method of manufacturing a pole according to claim 1, the method comprising the following successive steps:
providing an extruded blank; and
cutting the extruded blank to a length corresponding to the length of the extrusion.
